(19) United States
(12) Patent Application Publication
(10) Pub. No.: US 2003/0031455 A1
(43) Pub. Date: Feb. 13, 2003

(54) Automatic commercial skipping service

(75) Inventor: Richard Bryan Sagar, Santa Clara, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/927,305

(22) Filed: Aug. 10, 2001

(51) Int. Cl. G06F 17/60; H04N 7/025; H04N 7/10; H04N 9/79

(52) U.S. Cl. 386/35; 725/32; 705/14

(57) ABSTRACT

A business model is provided for the entertainment industry. In this model a service provider delivers a content information to a device of a subscriber. Upon a first fee, the user is provided with the content information that comprises a commercial information. The device of the user is configured to enable the user to manually skip the commercial information when playing out the buffered content information. In this business model, a second tier of service level is offered. In return to an additional fee, the user is offered to have his device enabled to automatically skip the commercial information.

### FIELD OF THE INVENTION

The invention relates to information distribution.

The invention is relevant, however non exclusively, to entertainment services such as personal radio services or personal television services.

### BACKGROUND ART

Video recorders enable skipping of commercials by fast forwarding through them when watching a previously recorded program. With new hard-disk drive based recorders it is possible to skip commercials in “live” television. Technically, this requires that the program that the individual is watching, is buffered via a video cache on the hard-disk drive and the program played-out is actually slightly time-shifted. Users have been given means to customize their TV experience and as a consequence, the service provider partially lost control over the viewer's experience. The user is now able to decide when and what to watch or skip.

Several image processing techniques exist to detect and automatically skip commercials in multimedia content when recording content.

International patent application WO 01/35409 proposes one possible way of detecting commercials in a television program. This document proposes a method and apparatus for controlling an MPEG video media recording device to automatically identify and selectively skip segments of a video signal, such as commercial advertisements, during a recording session. During an MPEG video data recording session the system continuously monitors the video data being recorded to detect a scene change occurring over one or more image fields. In response to a detected scene change, the system stores in a file a time and record location on the media corresponding to the occurrence of the scene change. Depending upon the time interval between several of the detected scene changes, the system identifies a corresponding video segment as either a commercial advertisement or a chapter boundary. By identifying the segments in this way, the playback presentation can then be selectively controlled.

These emerging and available technologies become a threat to the entertainment industry and especially to the television industry. The wide acceptance of personal television may mean a drop in the advertising revenues of most TV broadcasters since commercial advertisements may not have the same impact on the audience as they used to have in the past. An approach of the entertainment industry towards this threat was to find solutions to prevent subscribers from skipping commercial advertisements when watching time-shifted TV programs.

International application WO 99/37045 proposes a digital radio broadcast system providing various interactive features including skip backward and skip forward. This document proposes tiers of service levels for non-paying and paying subscribers. A scheme is given that allows access control. A paying subscriber can listen to commercial-free audio, while the non-paying consumer hears a combination of music and advertisements. The paying user is provided with access points to bypass the commercials. As to the non-paying user, the fast forward and skip features of his device are disabled so that he cannot bypass the commercials.

### SUMMARY

An object of the invention is to propose an advantageous business model that can be mapped onto the various existing information distribution schemes.

It is another object of the invention to offer a business model responsive to users' behaviors that drastically changed with the arrival of new multimedia technologies and products.

To this end, a business method of the invention relates to a service provided to a user. The business method comprises transmitting a content information to a device of the user upon payment of a fee by the user. The content information comprises a commercial information. The device of the user is configured to enable skipping of any portion of the content information. Upon payment of an additional fee, the device of the user is enabled to automatically skip the commercial information when the content information is played out.

This business model gives a subscriber the possibility of paying an additional fee in order to have advertisements automatically removed from programs. In this model, the advertisement skipping feature becomes transparent to the user in the sense that the user is not manually skipping the advertisements any longer. In the invention, a device of a subscriber of the basic level of service permits manual skipping of the commercial advertisements, whereas a device of a subscriber of the enhanced service of the invention is configured to automatically skip commercial advertisements when the content information is played out. The content information may be temporally shifted to permit the device to process the content information and remove the commercial information before recording. A business method of the invention enhances existing information distribution models and moves in the direction of what the user wants while preserving a revenue stream generated through advertising.

In a further embodiment of the invention, the method also comprises enabling the device to record the content information without the commercial information.

In this embodiment, only part of the received content information is recorded on a storage arrangement of the device. Thus, no other processing of the content information is necessary in real-time while playing out the recorded content information. The recorded content information can be played as such and, as a result, the user viewing experience can be optimized.

The commercial information may represent a temporal segment in a video program and a signal may be transmitted to indicate the temporal occurrence of the commercial segment. The signal may, for example, indicate the beginning and the end of the commercial segment in the content information. The commercial information may also be a set of data inserted in the content information such as a video object inserted in a picture field or in a sequence of successive MPEG frames.

In a further embodiment of the invention, the automatic skipping of the commercial information may be disabled by the user.

In this embodiment, the skipping of the advertisements is left at the discretion of the user to maximize his/her control over the program being played.

### BRIEF DESCRIPTION OF THE DRAWINGS

The invention is explained in further details, by way of examples, and with reference to the accompanying drawings wherein:

FIG. 1 illustrates a content distribution scheme of the invention;

FIG. 2 illustrates another content distribution scheme of the invention;

FIG. 3 to FIG. 5 are block diagrams of a device used in a method of the invention;

Elements within the drawing having similar or corresponding features are identified by like reference numerals.

### PREFERRED EMBODIMENT

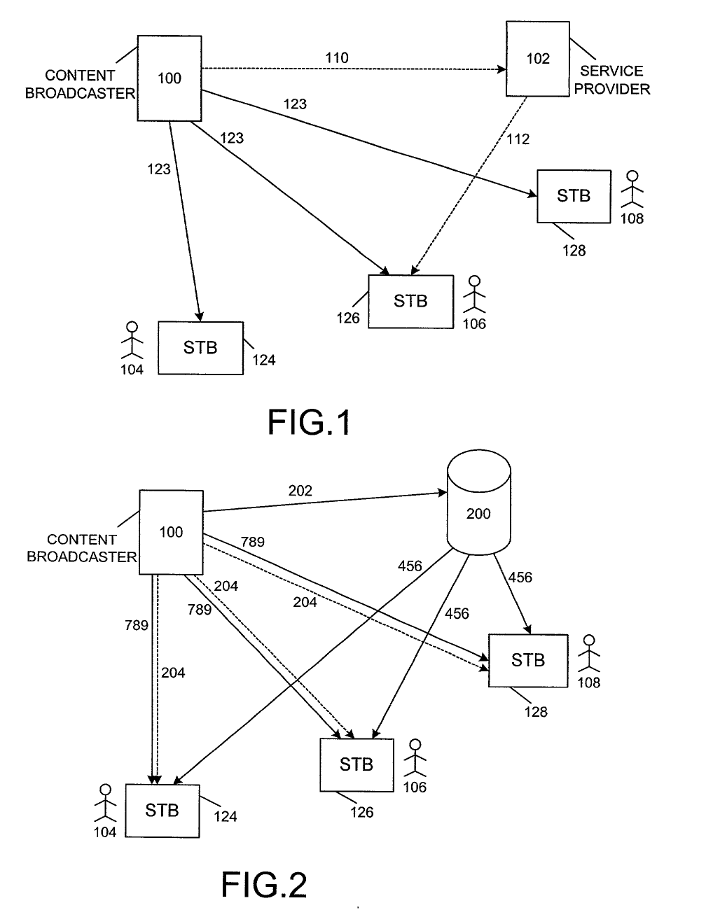

FIG. 1 illustrates a first embodiment of a business model of the invention. In this model a service provider 102 offers a personal television service. Such a service provider may be for example TIVO Inc., a leader and precursor in personal television services or MICROSOFT Corporation. A business model of the invention also comprises television programs broadcasting. The broadcasting may be analog or digital. To this end, a content broadcaster 100 transmits a content information 123 to subscribers 104, 106, 108. The content information 123 is transmitted over terrestrial cables, satellites, antennas or any other transmission means. The content information 123 is a set of data representing part of a television program, a full program or a sequence of programs and the content information 123 comprises commercial information 456, not represented in FIG. 1. The content information 123 and the commercial information 456 are hereafter referred to as content 123 and the commercial 456. Content 123 and the commercial 456 refer to both a piece of content to be encoded and the encoded data representing the piece of content. The commercial 456 may represent an advertisement segment temporarily interrupting content 123, e.g. the advertisement is a standard commercial break. The commercial 456 may also represent an advertisement object inserted in content 123. For example, content 123 is an MPEG-4 digitally encoded television program and the commercial 456 is an MPEG-4 object inserted in the field of one or more frames thereby, e.g. replacing an existing object in several successive displayed frames. For example, a logo advertising a sponsor may be inserted in the central round of a soccer field during game interruption periods. For example, the commercial 456 may be used in programmable product replacement. Alternatively, the advertising object is added in transparence to a portion of a displayed frame without, in this case, specifically replacing an object in the frame.

The subscribers 104-108 may subscribe to at least two tiers of service levels. A first tier corresponds to a basic service. In this embodiment, the users 104 and 108 have subscribed to this first type of service upon payment of a first subscription fee. The fee may be paid daily, weekly, monthly, on a lifetime basis or upon connection, e.g. phone line connection fee. As part of the basic service, the subscribers 104 and 108 are provided with a receiving device 124 and 128, respectively. The receiving devices 124 and 128, e.g. set top box, may be given for free, leased or retailed. The devices 124 and 128 are, for example, a TIVO set-top box or a MICROSOFT's ULTIMATE TV set-top box powering a digital video recorder and giving the users 104 and 108 a complete control over “live” television. In this embodiment, the receiving devices 124 and 128 respectively comprise a storage arrangement, e.g. a buffer, and are configured to enable fast forward and skip features when playing time-shifted content. The receiving devices 124 and 128 are configured to receive and play out content 123 received from the broadcaster 100.

The devices 124 and 128 also permit the users 104 and 108 to manually skip commercials when watching a buffered or memorized television program. The remote control provided with this type of device may comprise a skip button that allows skipping 30 seconds of a program being played from a memory unit. By pressing several time the skip button, the users 104 and 108 can jump over commercial breaks when watching a program stored in the storage arrangement of their respective devices 124 and 128. For example, the user 104 stores content 123 in the storage arrangement of the device 124. Later on, when playing out content 123, the user 104 manually controls the device 124 to jump over the commercial 456.

The service provider 102 also offers a second tier of service being an enhancement of the basic service. In this embodiment, the user 106 has subscribed to this enhanced service. This enhanced service of the invention permits to ameliorate the viewer's experience.

In this service, the subscriber 106 is also provided with a receiving device 126. The device 126 may be of the same type as the one provided to subscribers 104 and 108 of the basic service. The device 126 may also be of a different type with additional or distinct features. The receiving device 126 is equipped with a storage arrangement for temporarily storing television programs. The device 126 enables the skip and fast forward features. These features may be used to manually skip commercial advertisements or any other portion of a program temporarily stored in the storage arrangement.

The enhanced service comprises enabling the device 126 to automatically skip the commercial 456 detected in content 123. This may be done in different ways. A first possible way is to remove the commercial 456 before storing content 123 in the storage arrangement of the device 126. Content 123 can then be played out from the storage arrangement without the commercial 456. A second possible way is to store content 123 as it is received from the broadcaster 100, i.e. together with the commercial 456. The device 126 comprises a control unit that detects the commercial 456 from content 123 and controls the device 126 to jump over the commercial 456 when content 123 is played out from the storage arrangement. These various ways of automatically skipping the commercial 456 are explained in details hereinafter.

The embodiment of FIG. 1 illustrates a possible way of detecting the commercial 456 from content 123. The commercial 456 is a temporal segment inserted in content 123. The broadcaster 100 informs the service provider 102 of the location and/or length of the commercial 456 in content 123. For example, the broadcaster 100 transmits a signal 110 to the service provider 102 indicating the beginning and the end of the commercial 456. Content 123 may be indexed and the signal 110 gives the reference indicating where the commercial 456 is located in content 123.

From the signal 110, the service provider 102 is able to indicate to the device 126 the position of the commercial 456 in content 123. For example, the service provider 102 transmits a signal 112 to the device 126, the signal 112 being representative of an “enhanced” television guide. An electronic program guide (EPG) is typically an onscreen television guide that displays to the user channel and program information. A text-based EPG is similar to a printed television guide. A multimedia EPG allows the user to choose and record a program once, daily, or weekly at the touch of a button on the remote, sort through movies by theme, review top national and world news stories, and access comprehensive coverage of news, weather, sports, and entertainment stories. A typical multimedia EPG includes channel grids that contain present and future television programs and, in some instances, along with a video window that displays a current broadcast from a selected channel and a brief description of the program. In this embodiment, the signal 112 includes information necessary to enable the device 126 to locate the commercial 456 in content 123. The signal 112 includes a set of data associated with content 123 giving for example the channel, broadcasting content 123 or the name of the broadcaster 100, the time scheduled for broadcasting, the duration of content 123 and a brief summary. The signal 112 is such that this set of data also indicates the location of the commercial 456 in content 123. In this embodiment, the signal 112 represents an interactive program guide. Indeed, the user 106 can watch content 123 by selecting an icon associated with content 123 and displayed on an interactive program schedule grid. The information indicating the position and/or length of the commercial 456 may not be displayed to the user 106. The user 106 may not be able to read this information, which can be encrypted with a set of public/private keys as will be shown hereinafter. Thus, when the user 106 selects content 123, the device 126 can locate the commercial 456 in the received content 123 from the set of data associated with content 123. The device 126, configured for automatic advertisement skipping, is now able to skip the commercial 456 when playing content 123.

The enhanced service is available upon payment of an additional fee on top of the first fee paid for the basic service. The additional fee may be paid with the basic fee daily, weekly, monthly or on a lifetime basis. The additional fee may be a one time payment for having the advertisements automatically removed for a given period. In another business model of the invention, the additional fee is charged per commercial-free item stored in the storage arrangement of the device 126. The fee can also be charged per commercial-free viewing of a recorded program. The fee may also be based on the time of broadcast. Indeed skipping of commercials during a famous TV show played at a peak audience time may be charged higher than skipping commercials during a TV program played late at night. Other business models not mentioned here and based upon charging the subscriber for the additional service of automatically removing or jumping over advertisements when playing out a piece of content are also in the scope of the invention.

In an embodiment of the invention, the additional revenue incoming from subscribers of the enhanced service is redistributed to the content broadcaster 100 so that the broadcaster 100 can compensate the unavoidable drop in direct advertising revenue. However in this embodiment, the revenue stream does not flow directly from the user 106 to the content broadcaster 100. The service provider 102 collects the subscription fee paid by the user 106 and redistributes the collected revenue to the various broadcasters, e.g. the broadcaster 100. It is thus within the scope of the invention to consider that the broadcaster 100 is also providing a service to the user 106 according to a method of the invention. Indeed the broadcaster 100 broadcasts the content information 123, which is received by the user 106. Upon payment of the additional fee by the user 106, the broadcaster 100 enables the device 126 of the user 106 to automatically play advertisement-free content, e.g. by providing the signal 110 indicating the position of the commercial 456 in content 123. Thus, both the provider 102 and the broadcaster 100 provide a service according to a method of the invention. In another embodiment, the service provider 102 and the broadcaster 100 share the revenue resulting from the basic and the enhanced services.

It should be appreciated to those skilled in the art that information broadcast is not the only transmission technology being encompassed in the invention and any other transmission technology may be used, e.g. streaming or point-to-point transmission.

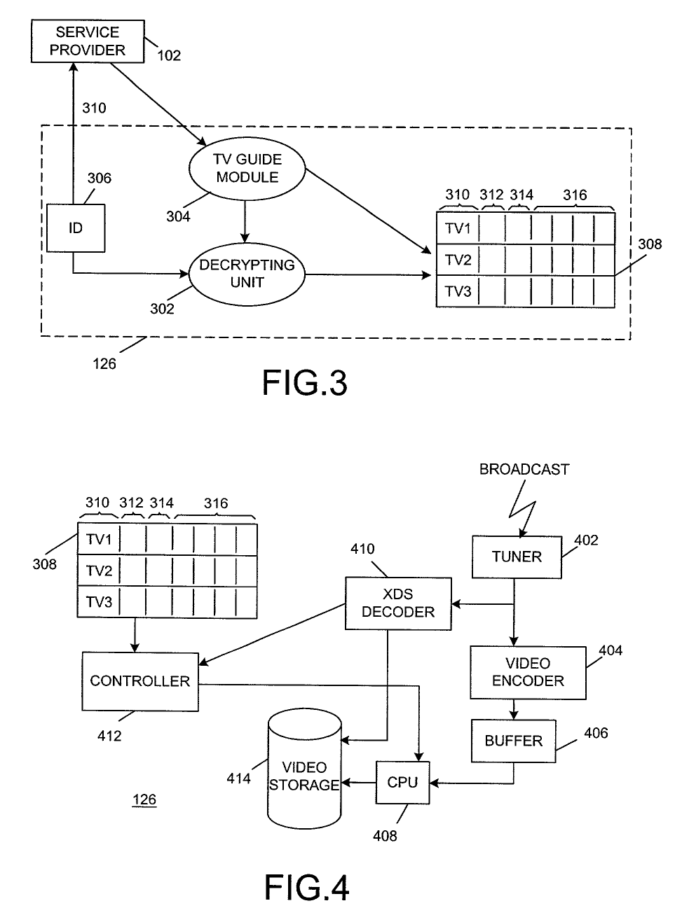

FIG. 2 is another block diagram illustrating another distribution scheme of the invention. The broadcaster 100 transmits content information 789. The content information 789 is a set of data representing a program or part of it, and is broadcast to the devices 124, 126 and 128. Content 789 does not comprise the commercial 456. The commercial 456 is received from an advertisement database 200. For example, the broadcasting of content 789 may be national whereas the transmission of the commercial 206 may be done locally in order to target a local audience with local advertisements. The commercial 456 can be inserted in content 789 locally at the devices 124-128. In another embodiment, the commercial 456 and content 123 are combined in an intermediary broadcast station near the devices 124-128. The commercial 456 can be inserted in content 789 when content 789 is played out live or when content 789 is locally recorded in the storage arrangement of the devices 124-128. The broadcaster 100 may communicate with the database 200 via link 202 to synchronize the broadcasting of content 789 and the broadcasting of the commercial 456.

For example, the users 104 and 108 have subscribed to the basic service and the user 106 has subscribed to the enhanced service. As mentioned previously, the device 126 is enabled to automatically skip the commercial 456 when playing out content 789. To this end, the broadcaster 100 transmits a signal 204 to the devices 124, 126 and 128. The signal 204 permits configuring the device 126 to automatically skip the commercial 456 when playing out content 789. The signal 204 may be a set of encrypted data that can only be read by the device 126. For example, the device 126 comprises a software application run by a controller, which is remotely actionable. In response to the signal 204, the controller runs the software application to configure the device 126 so that advertisement-free content can be played. The software application configures the device 126 to ignore the insertion of the commercial 456 in content 789 and as a result the device 126 plays content 789 as such.

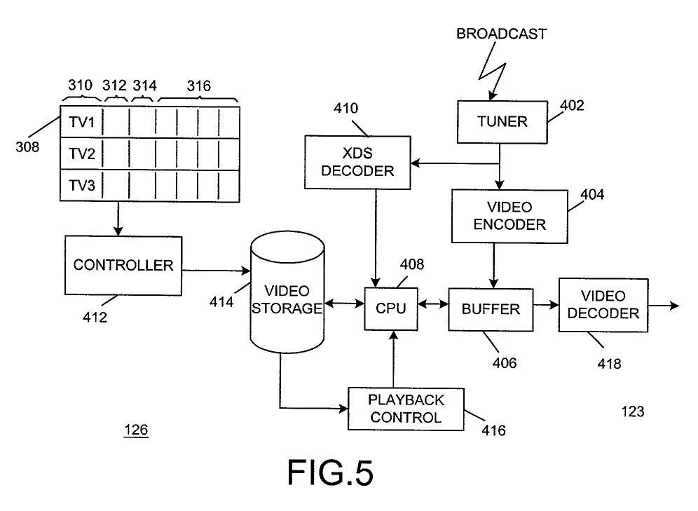

FIG. 3 is a block diagram of the device 126. The device 126 comprises a television guide module 304, a decrypting unit 302 and an identification unit 306. The device 126 needs to update on a regular basis the internally stored television guide. This is for example done weekly. To this end, the device 126 dials up, e.g. via a telephone line, to the service provider 102. When dialing up, the ID unit 306 transmits identification data 310 to the service provider 102. From data 310, the service provider 102 identifies the user 106 as a subscriber of the enhanced service. The provider 102 transmits the signal 112 to the device 126. The signal 112 represents the new television guide 308 and the signal 112 also comprises encrypted timestamps 316 indicating the position of the commercial 456 in content 123. The provider 102 can encrypt the timestamps 316 using the RSA public encryption technology. Public key encryption involves a pair of keys: a public key and a private key. The public key is known and the private key is kept secret. Data encrypted with the public key can only be decrypted with the private key. A private key has been stored in the ID unit 306. From the signal 310, the provider 102 can identify the public key to be used to encrypt data that the device 126 will be able to decrypt. The public key may be stored in the ID unit 306 or information identifying the public key may be stored in the unit 306. The provider 102 encrypts the timestamps 316 using this public key. The signal 112 is received by the module 304.

The module 304 renders the program guide 308 from the signal 112. The module 304 is configured to render a first field 310 of the guide 308 indicating the channel playing content 123 and indicating content 123 itself. The module 304 also renders a second field 312 and a third field 314 indicating respective beginning and end of broadcast of content 123. The fourth field comprising the timestamps 316 is rendered by the decrypting unit 302. The unit 302 decrypts the timestamps 316 using the private key provided by the ID unit 306. The timestamps 316 indicate the position and length of the commercial 456 in content 123. From the decrypted timestamps, the device 126 is able to skip the commercial 456 from content 123.

FIG. 4 is another example block diagram of the device 126. In this example, the device 126 removes the commercial 456 from content 123 before recording content 123 in a video storage unit 414.

A tuner 402 receives broadcast content 123 and transmits content 123 to a video encoder 404 and a XDS decoder 410. The XDS decoder 410 is capable of extracting, well-known in the art, XDS (Extended Data Services) data from content 123. The XDS data is transmitted in content 123 along with close caption data and text data. The XDS data comprises a program identification number that permits to identify the start time of content 123 and time and date relative to the coordinate universal time. The XDS data indicates the current time through a program. Thus, from the XDS data of content 123 the decoder 410 can indicate in real time the time elapsed in the playing or receiving of content 123. The decoder 410 provides a time reference for content 123. In this embodiment, the decoder 410 stores the elapsed time information in the video storage unit 414.

A video encoder 404 receives content 123 from the tuner 402. The encoder 404 encodes received content 123 in a format adapted for storage in the unit 414, e.g. MPEG-2. The encoder 404 provides encoded content 123 to a buffer 406 and a central processing unit 408 controls the transfer of encoded content 123 from the buffer 406 to the storage unit 414.

A controller 412 controls the commercial-free recording of content 123 in the storage unit 414. The controller 412 receives the elapsed time information associated with content 123 from the decoder 410. The decoder 410 may provide the elapsed time information to the controller 412 in real time simultaneously as the XDS data is extracted from received content 123. The controller 412 compares the elapsed time information and the timestamps 316 indicating the temporal occurrence of the commercial 456 in content 123. Based on the comparison, the controller 412 monitors the PCU to omit the recording of commercial 456 in the storage unit 414. Content 123 is stored in the unit 414 free of advertisement. The device 126 is then able to play commercial-free content 123.

Another example block diagram of the device 126 is given in FIG. 5. In this embodiment, content 123 is stored in the storage unit 414 with the commercial 456. The tuner 402 receives broadcast content 123 and transmits content 123 to the video encoder 404. The encoder 404 encodes content 123, e.g. in MPEG-2 format and transmits encoded content 123 to the buffer 406. The CPU 408 controls the transfer of content 123 from the buffer 406 to the unit 414. The decoder 410 extracts the XDS data from content 123 and deduces the elapsed time in the playing of content 123. The decoder 410 transmits the deduced elapsed time to the PCU 408 so that the elapsed time information may be multiplexed with encoded content 123 before storage in the unit 414. The controller 412 also provides the timestamps 316 to the storage unit 414.

The device 126 comprises a playback control unit 416 for controlling the play-out of content 123 stored in the unit 414. The unit 416 compares the elapsed time information and the timestamps 316, both stored in the unit 414, in order to detect the commercial 456 in content 123. The unit 416 controls the CPU 408 to jump over the commercial 456 when playing out content 123. Thus, commercial-free content 123 is transmitted to a video decoder 418, the decoder 418 playing out content 123 to the user 106.

The word “comprising” does not exclude the presence of other elements or steps than those listed in a claim.

What is claimed is:

1. A method of providing a service to a user, the method comprising:
upon payment of a first fee by the user, transmitting a content information comprising a commercial information to a device of the user, the device being configured to enable to skip any portion of the content information; and,
upon payment of an additional fee by the user, enabling the device of the user to automatically skip the commercial information when playing out the content information.

2. The method of claim 1, further comprising:
enabling the device to remove the commercial information when recording the content information.

3. The method of claim 1, further comprising:
transmitting a signal representative of a temporal occurrence of the commercial information; and,
enabling the device to interrupt a recording of the content information during the commercial information based on the signal.

4. The method of claim 1, further comprising:
transmitting a signal for identifying the commercial information in the information content; and,
enabling the device to omit the commercial information from a recording of the content information based on the signal.

5. The method of claim 1, wherein the device is enabled to automatically jump over the commercial information when playing out a recorded version of the content information.

6. The method of claim 1, further comprising:
enabling the user to inactivate the automatic skipping of the commercial information.

7. The method of claim 1, further comprising:
charging the additional fee for each automatic skipping of the commercial information.

8. The method of claim 1, further comprising:
broadcasting the content information.

9. The method of claim 1, further comprising:
streaming the content information to the device of the user.

10. The method of claim 1, wherein the content information is representative of a portion of television program.

11. The method of claim 1, wherein the content information is representative of a portion of a radio program.

12. A service provided to a user, the service comprising:
upon payment of a fee by the user, transmitting a content information comprising a commercial information to a device of the user, the device being configured to enable to skip any portion of the content information; and,
upon payment of an additional fee by the user, enabling the device of the user to automatically skip the commercial information when playing out the content information.

13. A method of enabling to provide a service to a user, the service comprising:
(i) upon payment of a fee by the user, transmitting a content information comprising a commercial information to a device of the user, the device being configured to enable to skip any portion of the content information;
(ii) upon payment of an additional fee by the user, enabling the device of the user to automatically skip the commercial information when playing out the content information.
wherein the method comprising enabling one of steps (i) and (ii).
